(19) United States
(12) Patent Application Publication
(10) Pub. No.: US 2012/0323682 A1
(43) Pub. Date: Dec. 20, 2012

(54) SYSTEMS AND METHODS FOR BEHAVIORAL MODELING TO OPTIMIZE SHOPPING CART CONVERSION

(75) Inventors: Amit Umesh Shanbhag, San Francisco, CA (US); Nausher Ahmed Cholavaram, San Jose, CA (US); Senthil Kumar Pandurangan, Cupertino, CA (US); Zeqian Shen, San Jose, CA (US); Dennis Decoste, Palo Alto, CA (US)

(73) Assignee: eBay Inc., San Jose, CA (US)

(21) Appl. No.: 13/524,187

(22) Filed: Jun. 15, 2012

Related U.S. Application Data
(60) Provisional application No. 61/497,451, filed on Jun. 15, 2011.

(51) Int. Cl. G06Q 30/02

(52) U.S. Cl. 705/14.51; 705/14.66

(57) ABSTRACT

Systems and methods for behavioral modeling to optimize shopping cart conversion are discussed. For example, a method can include identifying a user interacting with a networked system, accessing user profile data associated with the user, tracking user activity associated with the user, accessing a behavioral model, applying the behavioral model, and determining a shopping cart optimization. The behavioral model can be generated from historical data detailing interactions with the networked system. The behavioral model can be applied to the user profiled data and the user activity data to assist in selection of a shopping cart optimization.

### CROSS-REFERENCE TO RELATED APPLICATION

This application claims the benefit of U.S. Provisional Application No. 61/497,451, filed Jun. 15, 2011, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011, eBay, Inc. All Rights Reserved.

### TECHNICAL FIELD

This application relates generally to transactions over a distributed network, and more specifically to methods and systems for using behavioral model to optimize shopping cart conversion within network-based publication systems, network-based marketplace systems or commerce facilities.

### BACKGROUND

Retail establishments have long sought mechanisms to increase the amount and timeliness of customer purchases. Physical retail stores routinely place special offers at high traffic areas for the sole purpose of encouraging spontaneous add-on purchases. Online (e.g., network-based) retail web sites encounter additional technical challenges in identifying corresponding high-traffic areas. Online retailers also cannot easily utilize physical store layout to encourage customer to complete a purchase. Accordingly, online retail web sites can benefit from being able to identify and leverage avenues to encourage desired user behavior.

### BRIEF DESCRIPTION OF THE DRAWINGS

Some embodiments are illustrated by way of example and not limitation in the figures of the accompanying drawings in which:

FIG. 1 is a block diagram illustrating a shopping cycle and two sets of potential calls to action, according to an example embodiment.

FIG. 2A is a block diagram depicting a hierarchical classification Models to facilitate behavioral modeling, according to an example embodiment.

FIG. 2B is a text listing illustrating a more complicated hierarchical classification model, according to an example embodiment.

FIG. 3 is a block diagram illustrating a system for creating user behavior models, according to an example embodiment.

FIG. 4 is a block diagram illustrating a high level architecture to optimize conversion, according to an example embodiment.

FIG. 5 is a block diagram depicting a rule based engine with example inputs, according to an example embodiment.

FIG. 6 is a block diagram depicting a cart optimization architecture, according to an example embodiment.

FIG. 7 is a block diagram illustrating an example architecture for a network-based publication or marketplace system within which methods and systems using behavioral modeling to optimize shopping cart conversion can be implemented.

FIG. 8 is a block diagram illustrating multiple applications that, in one example embodiment, provided as part of the network-based publication system some of which can be used for behavioral modeling to optimize shopping cart conversion.

FIG. 9 is a block diagram illustrating an example system for dynamically issuing coupons used to optimize shopping cart conversion.

FIG. 10 is a block diagram illustrating an example behavioral modeling system, which can be implemented as part of a network-based publication system.

FIG. 11 is a flow chart illustrating an example method for optimizing shopping cart conversion using real-time behavioral modeling.

FIG. 12 is a diagrammatic representation of machine in the example form of a computer system within which a set of instructions for causing the machine to perform any one or more of the methodologies discussed herein may be executed.

### DETAILED DESCRIPTION

Example methods and systems to optimize shopping cart conversion using behavioral modeling are described. The systems and methods to optimize shopping cart conversion, in some example embodiments, may perform actions to prevent a user from abandoning a shopping cart containing items for purchase, may perform actions to increase the likelihood of a user in adding items to a shopping cart, or may perform actions that encourage a user to checkout (e.g., purchase) items currently in a shopping cart. The systems and methods all use different aspects of behavioral modeling to determine where in a shopping continuum a user is and use this information to trigger specific calls to action, such as increased merchandising, decreased merchandising, real-time messaging, or coupon presentment to encourage the desired activity. In the following description, for purposes of explanation, numerous specific details are set forth in order to provide a thorough understanding of example embodiments. It will be evident, however, to one skilled in the art that the present invention may be practiced without these specific details. It will also be evident that shopping cart conversion optimization using behavioral modeling is not limited to the examples provided and may include other scenarios not explicitly described herein.

The following abbreviations are used throughout this document: ATC—Add to Cart; RYP—Review your Purchases page; GMV—Gross Merchandise Value; CPM—Choose Payment Method page; RTM—Real Time Messaging; SME—Sales Merchandising Engine; CYP—Confirm your purchase page; PTC—Proceed to Checkout; and ETL—Extract, Transform, and Load (data warehousing).

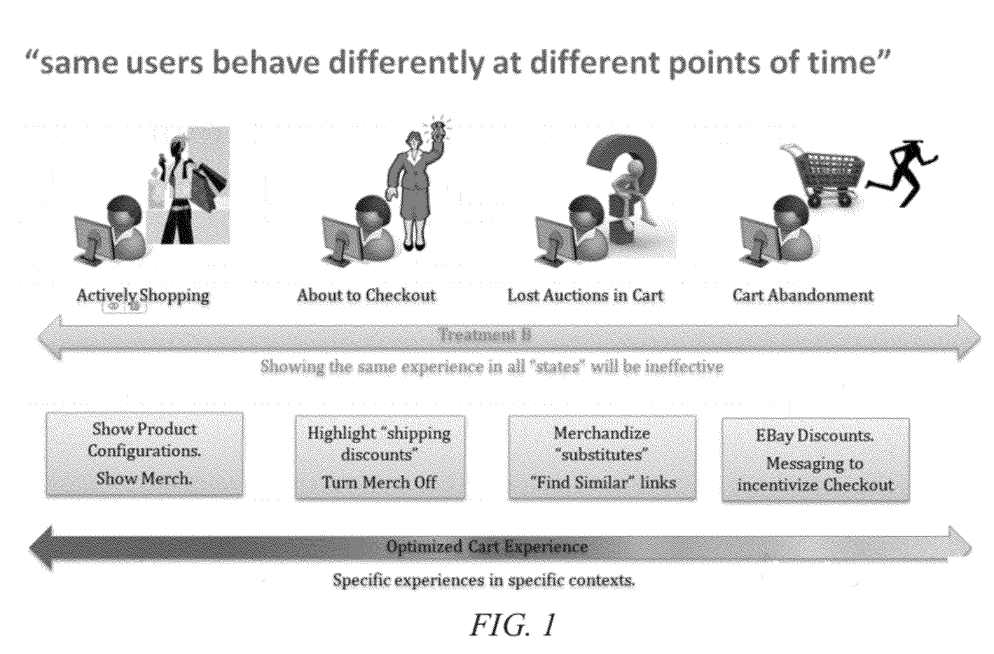

Typical online shopping behavior may include using a shopping cart or similar mechanism (e.g., wish list or watch list) as a repository to evaluate multiple options available for purchase. For example, if a user is shopping for a microwave oven, the user may select a number of potential options during an exploration shopping phase, putting each option in a shopping cart. The user is not intending to purchase all of the options selected and added to the shopping cart. Rather, the shopping cart is used as a mechanism to collect potential purchase options. As the user continues shopping, the user is likely to remove some of the options as the user draws closer to making a purchase (performing a checkout operation). During this shopping cycle different levels of messaging from the network-based marketplace or commerce facility can encourage or discourage movement towards checkout. For example, if high levels of merchandising continue throughout the shopping cycle, the user may be confused and never actually move to checkout (not being able to settle on one option). Alternatively, if merchandising is reduced or a valuable coupon is presented at the appropriate point in the shopping cycle, the user may be incented to make a final selection and checkout. FIG. 1 is a block diagram illustrating a shopping cycle and two sets of potential calls to action, according to an example embodiment.

In an example, the system can be adapted to detect and prevent shopping cart abandonment. A major loss of revenue within network-based marketplace or commerce facilities, which occurs when users abandon shopping carts after spending significant time searching, comparing, and adding items to a shopping cart. In some examples, the systems and method discussed below are also applicable to wish lists or watch lists, as these mechanisms share similar characteristics and may be used in a similar manner to encourage user behavior through targeted merchandising, messaging, or coupon presentment.

In an example, the system can be adapted to modulate merchandising according to detected user intent. For example, if the system detects, via behavioral modeling, that a user is nearing a typical checkout point in the observed shopping behaviors, the system can reduce the amount of cross-sell or up-sell merchandising targeted at the user. Reducing the amount of merchandising targeted at the user can reduce confusion and encourage the user to complete the checkout process. Alternatively, if the system detects that the user is still actively shopping, the system can increase merchandising targeted at the user to encourage the user to actively explore alternative purchase options, accessory purchase options, and cross-sell purchase options, among other things. In this example, the system may also be adapted to conduct urgency messaging. In certain scenarios, items within a user's shopping cart may not be available at a later date (e.g., auction-based items, low inventory items, etc. . . . ). In these scenarios, the system may be adapted to send messages to a user indicating that items may not be available for future purchase.

In additional examples, the system can be adapted to address a situation where the user has abandoned a shopping cart. For the purpose of this application abandoning a shopping cart can be defined as the user leaving un-purchased items within a shopping cart upon ending the current user-session with the network-based marketplace or commerce facility. In this example, the system may be adapted to determine predicted day of return, in other words the system can predict whether and when a user will return to an abandoned shopping cart and complete the transaction. In an example, the system may utilize the predicted day of return information to determine how and when to send messages to the user regarding the abandoned shopping cart. The following use-cases illustrate some example scenarios:

Use Case 1:
User is predicted to return to checkout within the next two days.
The system may be configured not to send any messaging, as the user is predicted to return without prompting.
This scenario indicates the checkout model predicted to be true (e.g., checkout model=true).

Use Case 2:
User is predicted to return to checkout (checkout model=true), but predicted day of return is greater than 2 days.
System may be configured to send emails after 24 hours with a frequency of once a day.

Use Case 3:
User is predicted to return in more than 6 days (checkout model likely to be false, cart has been abandoned).
System may be configured to send emails early and often (e.g., after 6 hours and twice a day).
Messaging may include a coupon or other incentive for user to return.

In an example, the system may be adapted to utilize behavior modeling to determine when a user is struggling with operation of the networked system. For example, when a new feature is implemented within the networked system, users may not understand the change, but are often reluctant to request assistance. In this scenario, the behavioral model system can be adapted to detect user struggles and provide appropriate assistance (e.g., pop-up help messages, live text-based assistance, etc. . . . ).

In an example, a system may be utilized that includes a behavioral modeling engine, a rules-based engine, and calls to action repository. In this system, the behavior modeling engine may determine what the user is like (e.g., profile including transient and persistent behaviors), what the user's current activities include, and what behaviors are likely to be exhibited based on the user's profile and current activities. The rules-based engine may then match calls to action from the repository to the user's behaviors. For example, two user behaviors relevant to optimizing shopping cart conversion may include checkout and abandonment. In this example, the system may be adapted to predict, based on a user's profile and current activities, whether the user is likely to checkout or abandon a shopping cart. Based on such a prediction, the rules-based engine may select different calls to action. For example, if checkout is predicted, the rules-based engine may select reducing merchandising related messaging. However, if abandonment is predicted, the rules-based engine may select coupon presentment (to incent the user to checkout instead of abandoning).

Shopping Cart Optimization:

Cart Optimization can include:

An effort to increase “Purchase Thru Rates” within the cart

Increase order size by stimulating impulse purchases (e.g., via merchandizing)

Reduce cart abandonment.

Aid “lost item” recovery.

Cart Optimization algorithms within an example can:

Learn who the user is?

Understand what the user is trying to do?

Understand what context the user is in?

Present the right calls to action.

Present the right incentives to stimulate desired behavior.

Serve relevant recommendations (e.g., merchandising).

In an example, the network-based marketplace is capable of “targeting user contexts” with “effective calls to action” and serving “relevant recommendations,” in a manner that causes the user to be more likely to checkout and less likely to abandon the shopping cart. In an example, the network-based system may utilize real-time classification algorithms in conjunction with behavioral models created offline to perform real-time behavioral analysis regarding user activities. In certain examples, the targeted user activities revolve around shopping cart use and general shopping activities such as exploring, comparing, and adding or removing items from a shopping cart or similar constructs, among others.

Real-time is used within the current specification to characterize computerized operations that occur as near real-time as is possible given the current state of computer technology. Almost no computer processing actually occurs in “real-time” or instantaneously, but computer systems envisioned for use within the current subject matter may be capable of processing transactions near real-time or on-the-fly. Real-time may be understood in contrast to offline batch processing of transactions or activities. In contrast to real-time operations, offline batch processing queues up transactions for processing at a later time, which may result in a noticeable delay to an end-user.

Real-Time User Intent:

In an example, shopping cart conversion optimization can use real-time user intent to determine what phase the users are currently in with regard to shopping cart use on the system. For example, a user may be in one of three different states, active shopping, checkout, or abandonment. For each of these example states, the system may be programmed to react with different levels of merchandising, coupon offers, or other promotional messaging to the user.

Persistent User Behaviors:

In an example, persistent behaviors are those behaviors exhibited by a user that do not fluctuate over time. Persistent behaviors can include any observable behavior that does not change from minute to minute. Example persistent behaviors can include the following examples, among others.

“Convenience shopper” behavior—Wants to buy items quickly, buys new or high quality items. The convenience shopper behavior may include the following attributes:
Identified by a proportion of “fixed price” items bought (versus auction items) on a network-based marketplace.
Application of filters, such as “buy-it now,” seeking items that can be purchased at a fixed price immediately, in contrast to items being auctioned off to the highest bidder over a period of hours, days, or weeks.

“Price Conscious” behavior—Strives for most value, shops on a budget. The price conscious shopper behavior may include the following attributes:
Identified by rarely buying new items (when used are available), uses a “price low-to-high” sort, or buys cheaper items in a given category.
Application of filters such as “cheap” or “used items.”

“Wary of scams” behavior—Willing to pay more for items from reliable sellers (as indicated by mechanisms such as feedback or reviews within a network-based marketplace). The wary-of-scams user may exhibit some of the following attributes:
User only buys items from top rated sellers within a network-based marketplace. For example, this user may only deal with sellers maintaining a 95% positive rating in feedback or reviews.
User may seek out recommended items from high rated or well-known sellers. User may filter out low rated sellers.

“Watch List User” behavior—Uses shopping cart, wish list, or watch list functionality to monitor selling within a network-base marketplace. The watch-list user may exhibit some of the following attributes:
Heavily use of wish lists, watch lists, or shopping carts for evaluation purposes.
Typically have very few actions such as “cart page views” and “remove items” (assuming the network-based marketplace includes a wish or watch list functionality).

The concept behind incorporating Persistent User behaviors into methods and systems for optimizing shopping cart conversion (e.g., increasing total merchandise in cart, approving checkout percentage, and lower shopping cart abandonment rates), is the idea of selling the right item to the right person at the right time. For example, it is easy to sell ramen noodles to graduate students when they are hungry. Accordingly, behavioral modeling algorithms used within a network-based system can process inputs to determine whether what persistent behaviors apply to a particular user. Knowledge of a particularly user's persistent behaviors can then be used to alter calls to action or other merchandizing techniques within the network-based system.

Transient User Behaviors:

In an example, transient user behaviors are those behaviors exhibited by a user that fluctuate over time. Transient behaviors can include any observable behavior that changes from minute to minute, between user sessions, or with another (relatively short) observable timeframe. In some examples, transient behaviors can include actions or activities not completely within a user's control, such as winning or losing an online auction. Example transient behaviors can include the following examples, among others.

“Exploration Mode”—If a user is rapidly adding lot of items to a shopping cart or wish list, the user is likely to be in exploration mode. A user's behavior within exploration mode can change rapidly over time as the user learns more about items available.

“Ready to Checkout”—A user may be ready to checkout if the user is observed removing recently added items from a shopping cart.

“Basket contains Lost Items”—This is an example of a transient behavior that may be outside the control of a user, the user has a shopping cart, wish list, or watch list that contains items from lost auctions or otherwise expired options. Optimization algorithms may trigger substitute merchandising to assist a user in replacing lost or expired items.

“Abandonment”—A user may indicate a level of frustration with purchase options by abandoning items in a shopping cart or wish list. Frustration can include lost auctions, roadblocks (e.g., poor user interface design or systems issues), or lack of interesting merchandise available.

Effective Calls to Action:

In an example, calls to action can include actions within a network-based system to encourage a user to perform a desired action. Calls to action can be grouped into various categories, such as increasing order size, stimulating checkout, avoiding cart abandonment, and lost item recovery. Increasing order size can include specific calls to action, such as displaying “add to cart” buttons, strikethrough pricing, highlighting shipping or other discounts, or suggesting combination sales to save on shipping, among others. Calls to action to stimulate checkout can include hiding merchandizing, prompts indicating shipping dates, or mechanisms to deemphasize certain navigation mechanism. Cart abandonment related calls to action can include instant savings coupons or offers, hiding merchandizing, or hiding navigation controls. Lost item recovery calls to action can include links to assist in finding similar items or substitute merchandizing. In an example, the system can utilize behavioral modeling to determine which of the available calls to action should be presented. Without mechanisms to determine a user's intent, such as behavioral modeling, the system would have to present all possible calls to action or randomly select from available options.

Cart Optimization:

In an example, cart optimization is performed by classifying user behavior associated with shopping on the network-based marketplace and using a shopping cart function. Note, in other examples, similar user behavior modeling may be performed in association with user behavior around a wish list or watch list, among other things.

Precision Versus Recall in a Classification Context:

In an example, various algorithms can be employed to predict user behavior such as abandonment. In the context of classification tasks, the terms true positives, true negatives, false positives and false negatives can be used to compare a given classification of an item or auction with the actual (or correct) classification. Table 1 illustrates an example.

TABLE 1
Classification Outcomes

| | | True Value | |
|---|---|---|---|
| | | XO = T | XO = F |
| Predicted Value | XO = T | Tp (true positive) | Fp (false positive) |
| | XO = F | Fn (false negative) | Tn (true negative) |

Within table one Tp and Tn indicate accurate predictions (e.g., predicted value equaled true value). Using the notation from Table 1, precision and recall can be defined as follows:

$$Precision = \frac{Tp}{Tp + Fp}$$

$$Recall = \frac{Tp}{Tp + Fn}$$

Recall in this context can also be referred to as the True Positive Rate. Other related measures used in classification algorithms can include True Negative Rate and Accuracy. The True Negative Rate can also be referred to as specificity.

$$True Negative Rate = \frac{Tn}{Tn + Fp}$$

$$Accuracy = \frac{Tp + Tn}{Tp + Tn + Fp + Fn}$$

In an example, the above formulas can be used to balance the impact of precision versus recall. For example, for abandonment, if precision is low the system may present calls to action (e.g., coupons) to more “false positives” or users that may not actually abandon their shopping cart. If recall is low, the system may retrieve fewer abandoners. Recall and precision will typically have an inverse relationship. In the examples discussed above, XO is used as an abbreviation for checkout, but can represent any desired user action within a network-based system.

In an example, behavioral modeling algorithms can be adjusted to favor prediction of one user action over another. For example, shopping cart optimization algorithms can be adjusted to favor prediction of the likelihood of checkout versus the likelihood of abandonment. In certain examples, the training dataset can also dramatically impact a behavioral models ability to make a prediction. For example, in a dataset biased towards checkout (e.g., many how checkout events versus abandonment events), an optimization algorithm may exhibit better precision when predicted checkout and much better recall when predicting checkout. Weighting factors can be used within an optimization model to correct for biased training sets.

In an example, behavioral model can be performed using algorithms such as linear regression, C-tree, Recursive Partitioning, or Random Forest, among others. Selection of algorithm as well as algorithm inputs, such as threshold values and sample sizes have been shown to impact precision and recall.

Model Structure and Creation

In an example, behavioral models can be at least partially created offline line using historical data collected by a network-based system. The collected data can include click stream data, transactional data, and user profile data, among other things.

In an example, the behavior models can be created offline using historical activity and profile data. Once created, the behavior models can be used online to perform real-time behavioral analysis through classification.

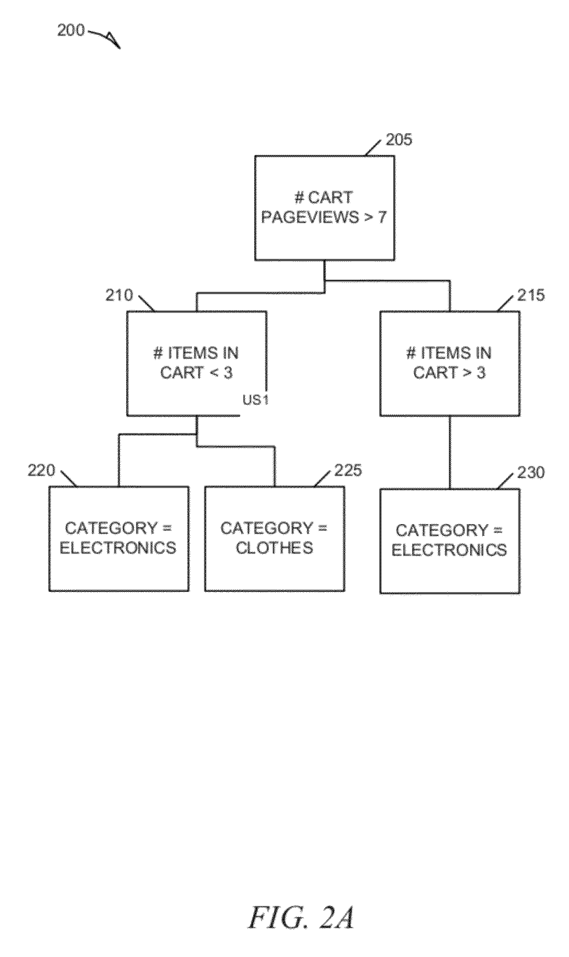

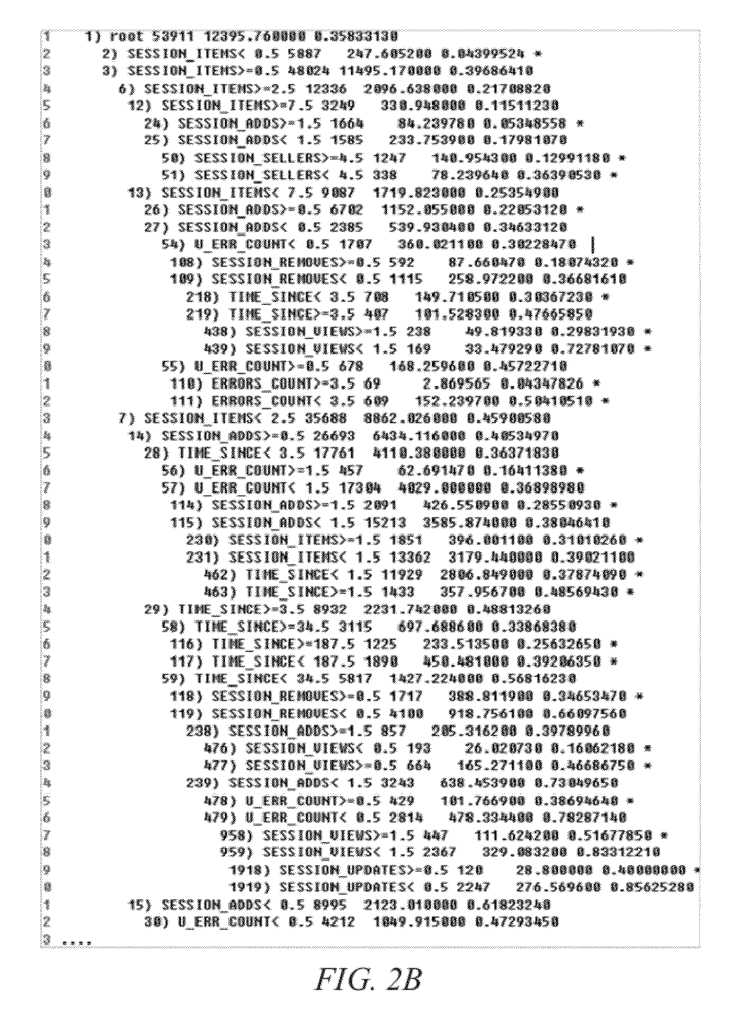

FIG. 2A is a block diagram depicting a hierarchical classification Models to facilitate behavioral modeling, according to an example embodiment. The example classification model includes a parent node 205, two child nodes 210, 215, and three grandchild nodes 220, 225, 230. The depicted model is a very simplistic representation of a hierarchical model. FIG. 2B is a text listing illustrating a more complicated hierarchical classification model, according to an example embodiment.

Each node if the hierarchical model may represent an attribute tracked within the network-based system, such as system 702, regarding a registered (or in some examples unregistered) user. Table 2 provides an example list of attributes that can be tracked within a network-based system and used within a classification model to assist in behavioral modeling.

TABLE 2
Example Attributes for Hierarchical Behavioral Models

| Priority | Column Name | Description |
|---|---|---|
| P1 | UID | UID of the user (best guess UID). NULL if not |
| | | Known. |
| P1 | GUID | GUID of the User |
| P1 | Log-In State | Logged-In, Logged-Out, Identified |
| P1 | Event Name | See Sheet3 for detailed names and explanation |
| | | of events |
| P1 | Session Avg Item Price | Running Average of Cart Price (sum price of all |
| | | cart items) |
| P1 | Session Min Item Price | Running Min of Cart Price (sum price of all cart |
| | | items) |
| P1 | Session Max Item Price | Running Max of Cart Price (sum price of all cart |
| | | items) |
| P1 | Session STD Item Price | Running STD of Cart Price (sum price of all cart |
| | | items) |
| P1 | Session Time Lapsed | Amount if time that has lapsed between this |
| | | event and start of session. |
| P1 | Session Cart Events | Sum of Cart Events in Browser Session |
| P1 | Session Cart View | Sum of Views(explicit “goto cart” or “cart Icon” |
| | | events) in Browser Session |
| P1 | Session Adds | Number of Times Buyer has added items to cart. |
| | | This is a running total up until that point of time. |
| P1 | Session Removes | Number of Times Buyer has removed item from |
| | | Cart. This is a running total up until that point of |
| | | time. |
| P1 | Session Items | Running Total of Items in the Cart |
| P1 | Session Listings | Running Total of Listings in the Cart (so Items = |
| | | Sum (Listings * Quantity) |
| P1 | Session Sellers | Running Total of Sellers in the Cart. |
| P1 | Session Messages | Running Total of Number of messages(page or |
| | | item-level) seen by the user in that session. |
| P1 | Session Speed Bumps | Running Total of Number of Speed Bumps seen |
| | | by the user in that session |
| P1 | Session Lost Auctions | Running total of Number of Lost Auctions seen |
| | | by the user in that session. |
| P1 | Session Ended Items | Running total of Number of Closed Listings seen |
| | | by the user in that session. |
| P2 | Event Load Time | Load Time in Seconds |
| P2 | Session #Categories Level | Number of unique categories that the items in |
| | 1(highest) | the cart, belong to (i.e cart = redshoes, black |
| | | shoes, iphone ===> value of this column is 2) |
| P2 | Dominant Category ID | ID of the most Dominant category (at that point) |
| | | (in above example, it would be CSA) |
| P2 | # Items in Dominant | #items in the most Dominant category (at that |
| | Category | point) (in above example, it would be 2) |
| P2 | Avg Seller ratings | Running Average ratings of sellers in the cart. |
| P2 | Avg Seller tenure | Running Average tenure of sellers in the cart. |
| P2 | Avg Seller Lifetime Value | Running Average Lifetime Value of sellers in |
| | | the cart. |
| P2 | # Seller Countries | Number of countries that the sellers in the cart |
| | | belong to. |
| P2 | Session Max Load Time | Max Load Time in Seconds, within that session, |
| | | for all events that have occurred so far. |
| P2 | Session Avg Load Time | Avg Load Time in Seconds, within that session. |
| | | ??? Is this is a running Average? |
| P2 | Max Item Staleness | Time elapsed since oldest item was added to the |
| | | cart |
| P2 | Min Item Staleness | Time elapsed since newest item was added to the |
| | | cart |
| P2 | Max Session Length | Largest session (time lapsed between first and |
| | | last event) for the user in a given day. If user has |
| | | only one session that day, then session length = |
| | | max session length. |
| P2 | Sessions per Day | Number of sessions for the user in a given day. |
| P3 | Item Title | Blob with names of all items in the cart. |
| P3 | Item Ids | Comma Separated list of ItemIds in the cart |
| P3 | Max Events Per Session | Max Daily Pageviews for that user, looking back |
| | | 3 weeks. |
| P3 | Avg Events Per Session | Cart PVs per day for a retrospective 3 week |
| | | window |
| P3 | Purchases per Day | Purchases per day for a retrospective 3 week |
| | | window |
| P3 | Similarity of Items in Cart | Euclidient Distance based on Product |
| | | Categories? |
| P3 | −ve Exp Pageview | Negative Exponentially Decaying Weighted Avg |
| | | of Pageviews for past 3 weeks (weighs recent |
| | | activity more heavily) |
| P3 | +ve Exp Pageview | Negative Exponentially Decaying Weighted Avg |
| | | of Pageviews for past 3 weeks (weighs distant |
| | | activity more heavily) |
| P1 | Checkout | Indicates if the next event is a checkout. So this |
| | | is true for the Event PRECEDING Checkout. |
| P1 | Steps Before Checkout | The number of events preceding Checkout (i.e 0 |
| | | when the checkout occurs, 1 for the pageview |
| | | immediately preceding the checkout and so on. |
| P1 | Abandonment | Indicates if the current event is an Abandonment |
| P1 | Steps preceding | The number of events preceding Abandonment |
| | Abandonment | (i.e. 0 when the checkout occurs, 1 for the |
| | | pageview immediately preceding the |
| | | abandonment and so on. |

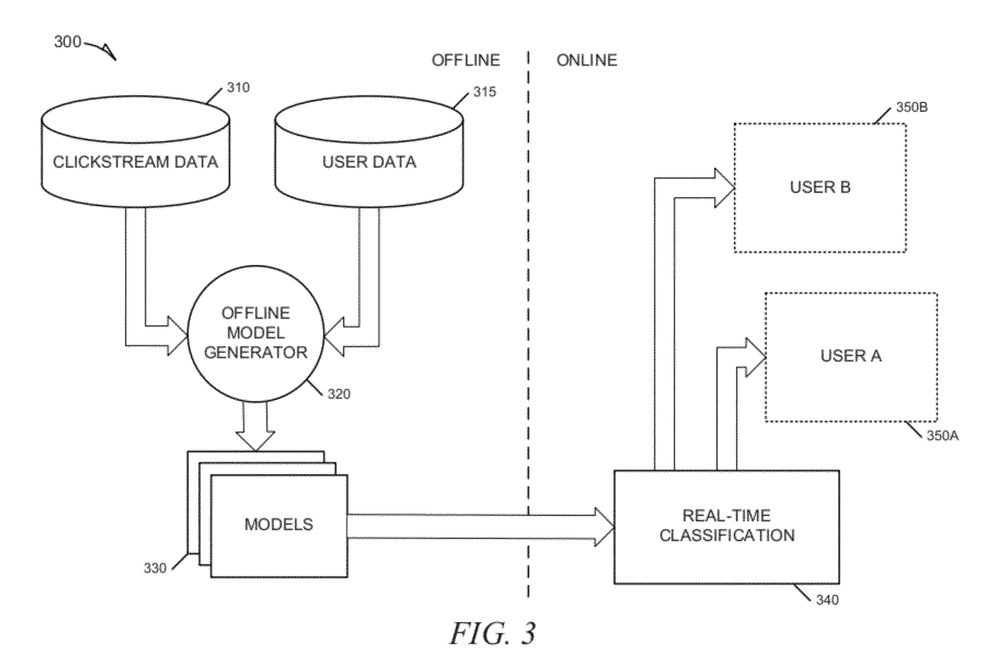

FIG. 3 is a block diagram illustrating a system 300 for creating user behavior models, according to an example embodiment. The system 300 can include a clickstream data source 310, a user data source 315, an offline model generator 320, one or more models 330, real-time classification engine 340, and output data representing one or more users 350A, 350B. In an example, the clickstream data source 310 can include historical data from a network-based system regarding transactions, page views, and other user generated data. The user data source 315 can include user profile type data. In an example, the offline model generator can access the clickstream data source 310 and the user data source 315 to generate behavioral models, such as models 330. In certain examples, the offline model generator can use algorithms such as linear regression, RandomForest, or k-nearest neighbor (k-NN), among others, to produce the models 330. In this example, the offline model generator runs periodically offline from a production network-based system, such as networked system 702.

The online side of FIG. 3 depicts the real-time classification engine 340 predicting behaviors of multiple users, user A 350A and user b 350B. In an example, the models 330 can be used by a real-time classification engine, such as real-time classification engine 340, to predict behavior of users interacting with a network-based system.

### System Architecture

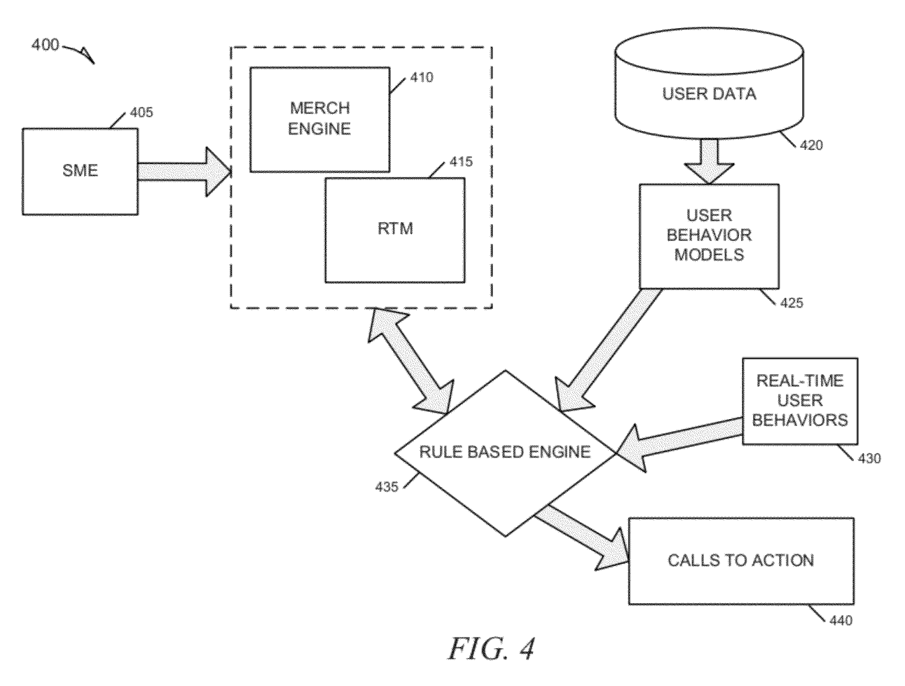

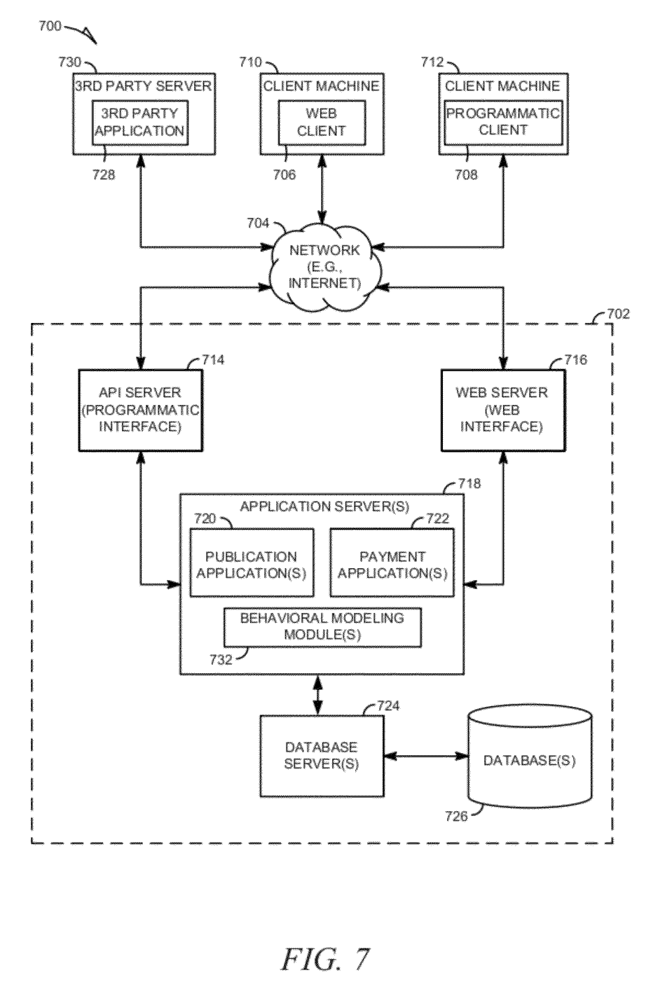

Behavioral modeling may utilize both user profile data and real-time activity information about the user's current use of a networked system, such as system 702 (illustrated in FIG. 7). User profile data can include age, gender, and historical behavior, among other things. A user's activity information can include searches performed, page views, shopping cart interactions, etc. . . . The behavioral modeling system can use various profile and activity information to build hierarchical models that can be used to within classification engines to classify current user activities in real-time. The classifications can then be used by a rules-based engine to match the activities to actions (e.g., merchandising or coupon presentment). Example system components and modules are described in further detail in reference to FIGS. 4 through 10.

FIG. 4 is a block diagram illustrating a high level architecture to optimize conversion, according to an example embodiment. In an example, a system 400 can include a sales merchandising engine (SME) 405, a merchandise engine 410, a real-time messaging component 415, a user data source 420, user behavior model repository 425, a real-time user behavior source 430, a rule based engine 435, and calls to action module 440.

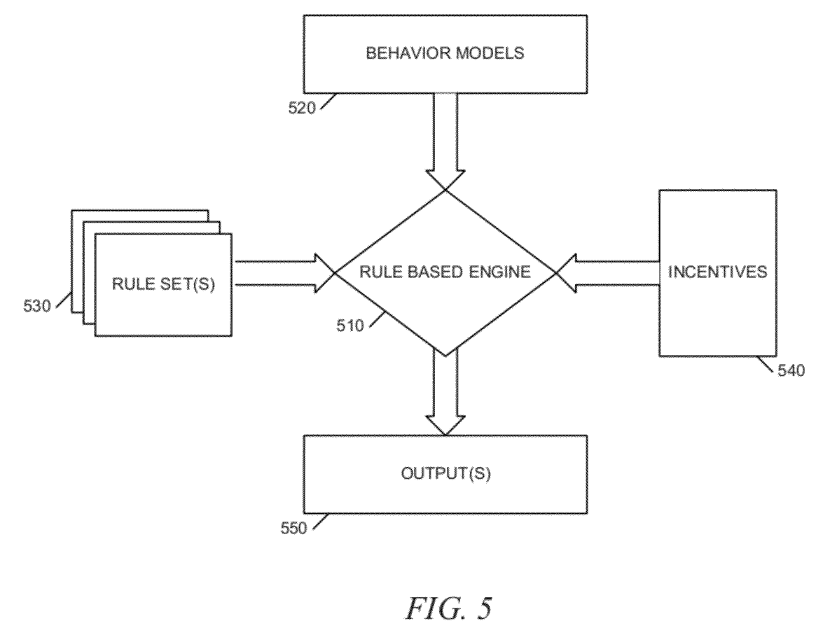

FIG. 5 is a block diagram depicting a rule based engine with example inputs, according to an example embodiment. The rule based engine 510 is where everything is brought together and applied during operation of a network-based system. The rule based engine can read and parse rules, find matching rules and execute actions (e.g., calls to action) to deliver an enhanced user experience. In this example, the rule based engine 510 can receive inputs such as behavior models 520, rule set(s) 530, and incentives 540. After processing the inputs, the rule based engine 510 can produce outputs 550 that may alter a user experience within a network-based system.

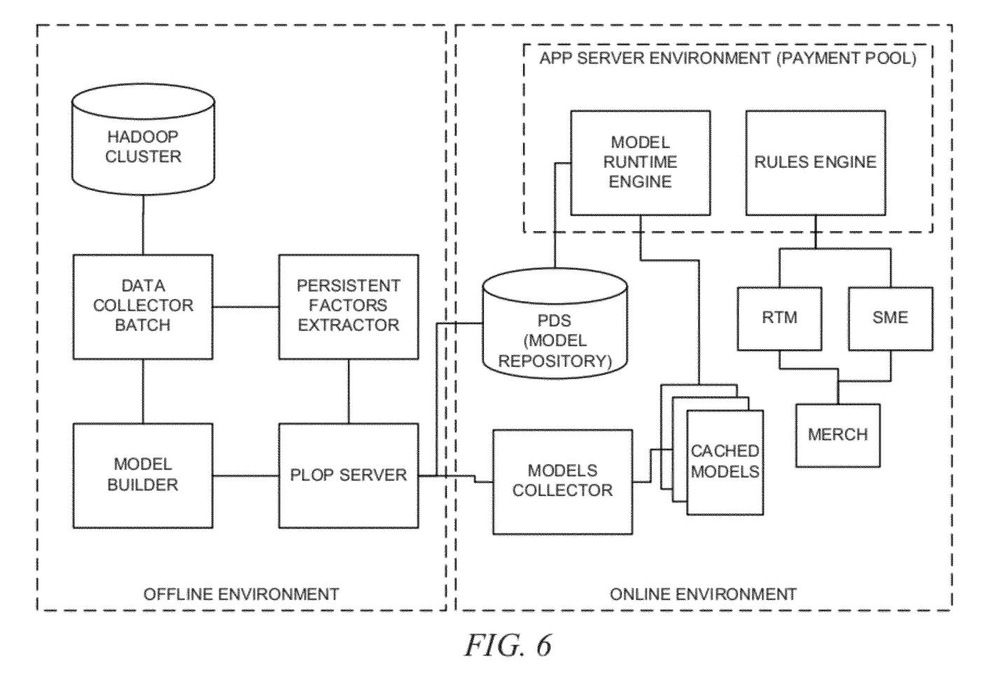

FIG. 6 is a block diagram depicting a cart optimization architecture, according to an example embodiment.

### Platform Architecture

FIG. 7 is a block diagram illustrating an example architecture for a network-based publication system within which methods and systems for behavioural modeling to optimize shopping cart conversion may be implemented. The block diagram depicting a client-server system 700, within which an example embodiment can be deployed. A networked system 702, in the example forms of a network-based marketplace, on-line retail site, or publication system, provides server-side functionality, via a network 704 (e.g., the Internet or Wide Area Network (WAN)) to one or more clients 710, 712. FIG. 7 illustrates, for example, a web client 706 (e.g., a browser, such as the INTERNET EXPLORER browser developed by Microsoft Corporation of Redmond, Wash. State), and a programmatic client 708 executing on respective client machines 710 and 712.

An Application Program Interface (API) server 714 and a web server 716 are coupled to, and provide programmatic and web interfaces respectively to, one or more application servers 718. The application servers 718 host one or more publication applications 720, payment applications 722, and coupon applications 732. The application servers 718 are, in turn, shown to be coupled to one or more databases servers 724 that facilitate access to one or more databases 726. In some examples, the application server 718 can access the databases 726 directly without the need for a database server 724.

The publication applications 720 may provide a number of publication functions and services to users that access the networked system 702. The payment applications 722 may likewise provide a number of payment services and functions to users. The payment applications 722 may allow users to accumulate value (e.g., in a commercial currency, such as the U.S. dollar, or a proprietary currency, such as “points”) in accounts, and then later to redeem the accumulated value for products (e.g., goods or services) that are made available via the publication system applications 720. The payment application 722 may also be configured to allow for the redemption of coupons issued during optimization activities. Behavioural modeling modules 732 may provide a number of modeling and tracking functions to facilitate optimization of shopping cart conversion. While the publication application 720, payment application 722, and behavioural modeling modules 732 are shown in FIG. 7 to all form part of the networked system 702, it will be appreciated that, in alternative embodiments, the payment applications 722 may form part of a payment service that is separate and distinct from the networked system 702.

Further, while the system 700 shown in FIG. 7 employs a client-server architecture, the present invention is of course not limited to such an architecture, and could equally well find application in a distributed, or peer-to-peer, architecture system, for example. The publication application 720, payment application 722, and behavioural modeling module 732 could also be implemented as standalone software programs, which do not necessarily have networking capabilities.

The web client 706 accesses the various publication, payment, and coupon applications 720, 722 and 732 via the web interface supported by the web server 716. Similarly, the programmatic client 708 accesses the various services and functions provided by the publication and payment applications 720 and 722 via the programmatic interface provided by the API server 714. The programmatic client 708 may, for example, be a seller application (e.g., the TURBOLISTER application developed by eBay Inc., of San Jose, Calif.) to enable sellers to author and manage listings on the networked system 702 in an off-line manner, and to perform batch-mode communications between the programmatic client 708 and the networked system 702. Programmatic clients 708 can also be provided that enable sellers to author and manage coupons and coupon campaigns on the networked system 702 in either an on-line or off-line mode.

FIG. 7 also illustrates a third party application 728, executing on a third party server machine 730, as having programmatic access to the networked system 702 via the programmatic interface provided by the API server 714. For example, the third party application 728 may, utilizing information retrieved from the networked system 702, support one or more features or functions on a website hosted by the third party. The third party website may, for example, provide one or more promotional, publication or payment functions that are supported by the relevant applications of the networked system 702. Additionally, the third party website may provide a user access to view coupons issued by the networked system 702.

### Publication Applications

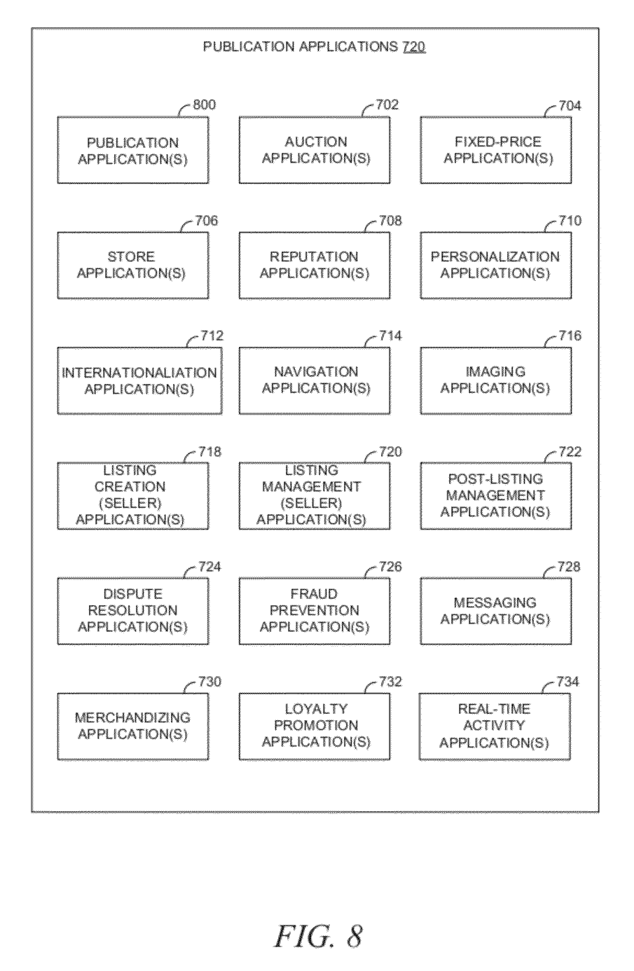

FIG. 8 is a block diagram illustrating multiple applications 720 that, in an example embodiment, are provided as part of the networked system 702. The applications 720 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 726 via the database servers 728.

The networked system 702 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the publication applications 720 may include at least one publication application 800 and one or more auction applications 802 which support auction-format listing and price setting mechanisms (e.g., English, Dutch, Vickrey, Chinese, Double, Reverse auctions etc.). The various auction applications 802 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 804 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 806 allow a seller to group listings within a “virtual” store, which may be branded and otherwise personalized by and for the seller or merchant. Such a virtual store may also offer promotions, incentives and features that are specific and personalized to a relevant seller. The coupon modules 914 are configurable to provide coupon related services through the store applications 206 to individual sellers. In this example, individual sellers can access many of the coupon related functions described herein. For instance, through the coupon modules 914 a seller can create a coupon campaign specific to the seller's personalized “virtual” store.

Reputation applications 808 allow users that transact, utilizing the networked system 702, to establish, build and maintain reputations, which may be made available and published to potential trading partners. Consider that where, for example, the networked system 702 supports person-to-person trading, users may otherwise have no history or other reference information whereby the trustworthiness and credibility of potential trading partners may be assessed. The reputation applications 808 allow a user, for example through feedback provided by other transaction partners, to establish a reputation within the networked system 702 over time. Other potential trading partners may then reference such a reputation for the purposes of assessing credibility and trustworthiness.

Personalization applications 810 allow users of the networked system 702 to personalize various aspects of their interactions with the networked system 702. For example a user may, utilizing an appropriate personalization application 810, create a personalized reference page at which information regarding transactions to which the user is (or has been) a party may be viewed. A personalized reference page is configurable to display all coupons issued to the user by one of the coupon applications 732 or stored within the coupon infrastructure 904. Further, a personalization application 810 may enable a user to personalize listings and other aspects of their interactions with the networked system 702 and other parties. Additionally, a personalization application can enable a user to view and organize coupons issued by the publication system or individual merchants within the publication system.

The networked system 702 may support a number of publication systems that are customized, for example, for specific geographic regions. A version of the networked system 702 may be customized for the United Kingdom, whereas another version of the networked system 702 may be customized for the United States. Each of these versions may operate as an independent publication system, or may be customized (or internationalized) presentations of a common underlying publication system. The networked system 702 may accordingly include a number of internationalization applications 812 that customize information (and/or the presentation of information) by the networked system 702 according to predetermined criteria (e.g., geographic, demographic or publication system criteria). For example, the internationalization applications 812 may be used to support the customization of information for a number of regional websites that are operated by the networked system 702 and that are accessible via respective web servers 716.

Navigation of the networked system 702 may be facilitated by one or more navigation applications 814. For example, a search application (as an example of a navigation application) may enable key word searches of listings published via the networked system 702. A browse application may allow users to browse various category, catalogue, or inventory data structures according to which listings may be classified within the networked system 702. Various other navigation applications may be provided to supplement the search and browsing applications. Certain navigation applications may be configured to surface coupons relevant to the search or browsing pages delivered in response to a user's query.

In order to make listings, available via the networked system 702, as visually informing and attractive as possible, the publication system applications 720 may include one or more imaging applications 816 utilizing which users may upload images for inclusion within listings. An imaging application 816 also operates to incorporate images within viewed listings. The imaging applications 816 may also support one or more promotional features, such as image galleries that are presented to potential buyers. For example, sellers may pay an additional fee to have an image included within a gallery of images for promoted items.

Listing creation applications 818 allow sellers conveniently to author listings pertaining to goods or services that they wish to transact via the networked system 702, and listing management applications 820 allow sellers to manage such listings. Specifically, where a particular seller has authored and/or published a large number of listings, the management of such listings may present a challenge. The listing management applications 820 provide a number of features (e.g., auto-relisting, inventory level monitors, etc.) to assist the seller in managing such listings. One or more post-listing management applications 822 also assist sellers with a number of activities that typically occur post-listing. For example, upon completion of an auction facilitated by one or more auction applications 802, a seller may wish to leave feedback regarding a particular buyer. To this end, a post-listing management application 822 may provide an interface to one or more reputation applications 808, so as to allow the seller conveniently to provide feedback regarding multiple buyers to the reputation applications 208.

Dispute resolution applications 824 provide mechanisms whereby disputes arising between transacting parties may be resolved. For example, the dispute resolution applications 824 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 826 implement fraud detection and prevention mechanisms to reduce the occurrence of fraud within the networked system 702.

Messaging applications 828 are responsible for the generation and delivery of messages to users of the networked system 702, such messages for example advising users regarding the status of listings at the networked system 702 (e.g., providing “outbid” notices to bidders during an auction process or to provide promotional and merchandising information to users). The messaging applications 828 can also be used to deliver real-time messages or coupons generated at the request of the behavioural modeling modules 732 to users on the networked system 702. Respective messaging applications 828 may utilize any one of a number of message delivery networks and platforms to deliver messages to users. For example, messaging applications 828 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks. The messaging applications 828 may also be configured to communicate over certain social networking platforms, such as Twitter or Facebook. Communication with a social networking platform may require installation of an application or plug-in within a user's social network account.

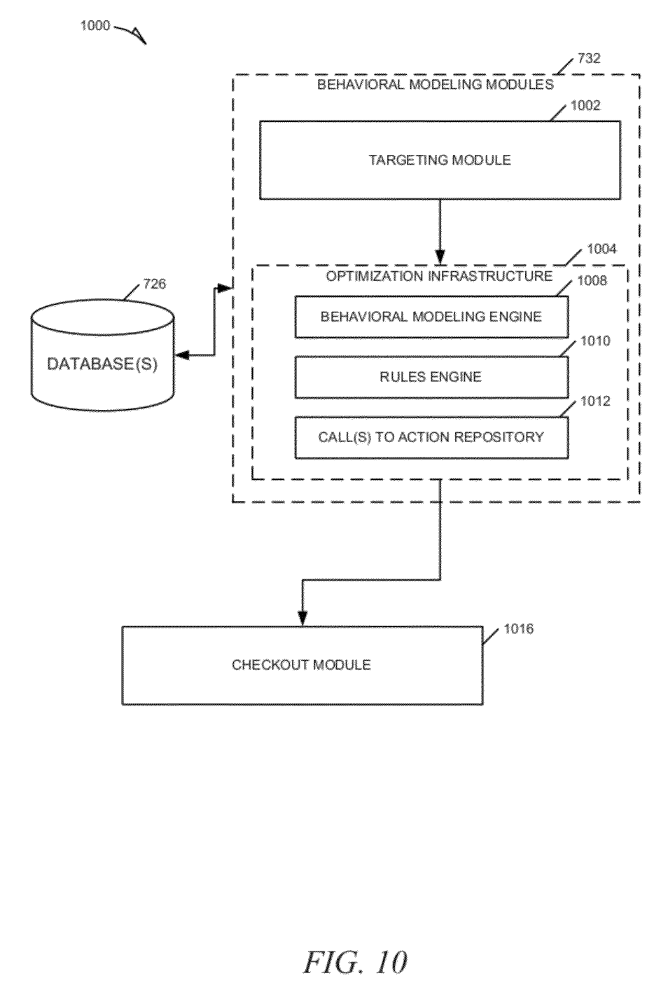

Merchandising applications 830 support various merchandising functions that are made available to sellers to enable sellers to increase sales via the networked system 702. The merchandising applications 830 also operate the various merchandising features that may be invoked by sellers, and may monitor and track the success of merchandising strategies employed by sellers. The merchandising applications 830 may also provide an additional mechanism for sellers to create and manage coupon campaigns within the networked system 702. The merchandising application 830 may also be utilized by the behavioural modeling modules 732 or optimization modules 1014 (discussed in reference to FIG. 10) to optimize shopping cart conversion with appropriate merchandising to users based on behavioural modeling of real-time activities within the networked system 702.

The networked system 702 itself, or one or more parties that transact via the networked system 702, may operate loyalty programs that are supported by one or more loyalty/promotions applications 832. For example, a buyer may earn loyalty or promotions points for each transaction established and/or concluded with a particular seller, and are offered a reward for which accumulated loyalty points can be redeemed. The loyalty promotion applications 832 may work in conjunction with the coupon modules 314 or optimization modules 1014 to reward loyal users with valuable coupons for use within the networked system 702.

Real-time activity applications 834 support various functions within the networked system 702 by providing real-time information about user activities within the networked system 702. For example, the real-time activity applications 834 can provide information to the messaging applications 828 or personalization applications 810 to enhance a user's experience or improve a seller's ability to move merchandise. In certain examples, the real-time activity applications 834 provide real-time activity data to the behavioural modeling modules 732, coupon modules 914, or optimization modules 1014 enabling real-time, instantaneous delivery of user targeted messages, merchandising, or coupons. Real-time activity data, delivered by the real-time activity applications 834, may also be used to coordinate delivery of coupons within the networked system 702 and through external communications channels supported by the messaging applications 828. The real-time activity data can also be used to trigger contextual display of coupons already issued to the user. For example, if the user is viewing an item listing for a digital camera, this information can be provided to the coupon modules 914, which can then trigger the display of a coupon from a seller specializing in digital cameras.

### Coupon Modules

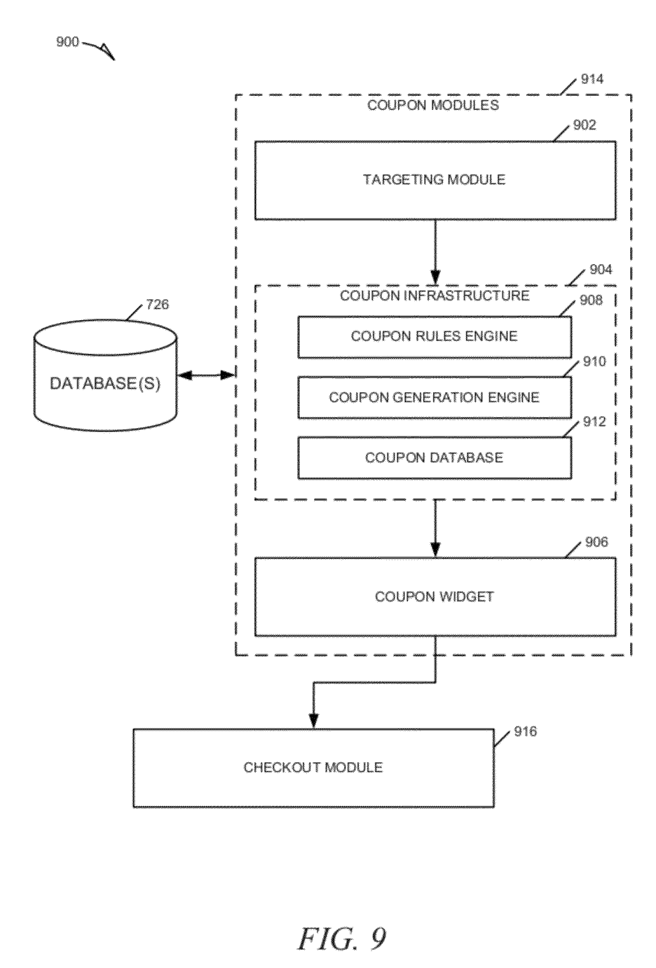

FIG. 9 is a block diagram illustrating an example couponing system 900 for dynamically issuing coupons. Targeted coupon delivery is a key component of shopping cart conversion optimization. The delivery of a well-timed coupon may prevent shopping cart abandonment and lead directly to the user checking out items within a cart. As shown in the example illustrated by FIG. 9, the system 900 includes coupon modules 914, a checkout module 916 and the databases 726. The coupon modules 914 include a targeting module 902, a coupon infrastructure 904, and a coupon widget 906. In certain examples, the coupon infrastructure 904 includes a coupon rules engine 908, a coupon generation engine 910, and a coupon database 912. The coupon database 912 can be a separate stand-alone database within the coupon infrastructure 904 or it can be one or more interconnected tables within the databases 126.

The targeting module 902 is configurable to create coupon issuance models used by the coupon infrastructure 904 to generate coupons for users of the networked system 702. The targeting module 902 is configurable to create lists of users that are eligible to be issued coupons. In an example, the targeting module 902 receives instructions from one or more of the publication system applications 120 to pull data from the databases 126 to create lists of coupon eligible users. In certain examples, the targeting module 902 stores various coupon issuance models within the databases 126 for use in future couponing campaigns. The coupon issuance models can include various conditions that are evaluated by the coupon infrastructure 904 in determining whether to issue a coupon. In certain examples, the targeting module can deliver coupons through the messaging applications 228, based on a list of eligible users.

The coupon infrastructure 904, in some example embodiments, is responsible for evaluating coupon issuance models, generating and storing coupons for use by users within the networked system 702. In an example, the coupon infrastructure 904 includes a coupon rules engine 908 that can be used to evaluate one or more coupon issuance models. In certain examples, the coupon rules engine 908 also determines whether a targeted user is on a list of users eligible to receive a coupon, before signalling the coupon generation engine 910 to create a coupon. In another example, the coupon rules engine 908 can select contextually relevant coupons for presentation to the user. In this example, the coupon rules engine 908 receiving information regarding a user's current location, environment and/or context within the networked system 702 to determine which coupons may be relevant for display. In certain examples, the coupon generation engine 910 can generate a coupon represented by coupon metadata, shown below in Table 1 as example XML tags. In other examples, the coupon generation engine 910 generates coupons through interaction with the coupon database 912. The coupon database 912, in some example embodiments, stores all generated coupons for use within the networked system 702. The coupon infrastructure, in certain example embodiments, is configured to transmit coupons through communication channels external to the networked system 702. In some examples, the coupon infrastructure uses the messaging applications 228 to handle communication of coupons.

TABLE 1
Example Coupon Metadata

```
<CouponMetadata>
  <summary_action>insert</summary_action>
  <external_id>123456</external_id>
  <program_code>CRTYS200</program_code>
  <adjacency_id>0</adjacency_id>
  <incentive_type>3</incentive_type>
  <coupon_value_type>1</coupon_value_type>
  <coupon_application_type>1</coupon_application_type>
  <coupon_type>1</coupon_type>
  <iso_country_code>US</iso_country_code>
  <language>EN</language>
  <iso_currency_code>USD</iso_currency_code>
  <budget_amount>300000</budget_amount>
  <start_date>02/01/2008 14:59:59</start_date>
  <expiration_date>05/23/2008 00:59:59</expiration_date>
  <category_id>14339, 12314, 92382</category_id>
  <status>1</status>
  <display_message><![CDATA[This is a custom description. The offer
  is {offer}%, up to ${max}. Min purchase is ${min}.]]>
  </display_message >
  <min_purchase_amount>200</min_purchase_amount>
  <coupon_max_discount_amount>500</
  coupon_max_discount_amount>
  <faq_url>http://www.mpname.com/us_termsfaq.html</faq_url>
  <coupon_discount_percent>14.5</coupon_discount_percent>
  <incntv_max_usage_count>5</incntv_max_usage_count>
</CouponMetadata>
```

The coupon widget 906 is configurable to present coupons generated by the coupon infrastructure 904 to a user accessing the networked system 702. In certain examples, the coupon widget can also be configured to communicate coupons over various communication channels, both internal and external to the networked system 702, such by leveraging the messaging applications 228. In some examples, the coupon widget 906 may be a small applet that runs within a third party application 128 to display coupons to registered users of the network system 702. For example, a Facebook application can incorporate the coupon widget 906 and be configured to display coupons to a user within the user's Facebook account. In these examples, the coupon widget 906 is configurable to communication through the API server 114 in order to access the coupon infrastructure 904. In these various examples, the coupon infrastructure can coordinate delivery of a targeted coupon to a user through both the coupon widget 906 and the messaging applications 228. The coupon widget can also present contextually relevant coupons selected by the coupon rules engine 908 based on current user interactions with the networked system 702.

The checkout module 916 is configurable to allow a user of the networked system 702 to complete the purchase process. The coupon widget 906 is configurable to work in conjunction with the checkout module 916 to present contextually relevant coupons to the user during the checkout process. In some examples, the coupon widget 906 can display only those coupons that can be applied to the items the user is attempting to checkout using the checkout module 916. In certain examples, the checkout module 916 can support selection of coupons stored in the coupon infrastructure 904 as well as entry of legacy coupon codes.

### Optimization Modules

FIG. 4 is a block diagram illustrating an example behavioral modeling system 1000, which can be implemented as part of a network-based publication system. The system 1000 can include behavioral modeling modules 732, checkout module 1016, and database 726. In some examples, the behavioral modeling modules 732 can include targeting module 1002 and optimization infrastructure 1004, which can include behavioral modeling engine 1008, rules engine 1010, and call to action repository 1012.

The targeting module 1002 is configurable to create behavioural models used by the optimization infrastructure 1004 to generate calls to action (e.g., merchandising, offers, coupons, user interface changes, etc. . . . ) for users of the networked system 702. The targeting module 1002 is configurable to create lists of users that are actively using the networked system 702. In an example, the targeting module 1002 receives instructions from one or more of the publication system applications 720 to pull data from the databases 726 to create lists of eligible users. In certain examples, the targeting module 1002 can pre-filter user sessions on the networked system 702 for targeting with optimization actions via the optimization infrastructure 1004. In other examples, the targeting module 1002 may simply maintain a list of active users.

In an example, the behavioral modeling engine 1008 can create behavioral models from historical clickstream, transaction, and user profile data, which may be stored in database 726. In other examples, the behavioral modeling engine 1008 may merely extract behavioral models stored in database 726 for use by the rules engine 1010.

In an example, the rules engine 1010 can use behavioral models obtained from the behavioral modeling engine 1008 and real-time data from the networked system 702 to determine what calls of action to invoke for a particular user. The rules engine 1010 can evaluate a user's position within a shopping cycle to determine the optimal manner to incent desired behavior. For example, the rules engine 1010 can evaluate a user's shopping cart or wish list behavior and determine appropriate actions to incent the user to checkout items in these lists.

In an example, the call to action repository 1012 can include a collection of potential calls to action that can be selected by the rules engine 1010 based on user interactions on the networked system 702. Calls to action can include coupons, special offers, user interface modifications, messaging (text, email, etc. . . . ), or other actions presented to a user of the networked system 702.

The checkout module 1016 is configurable to allow a user of the networked system 702 to complete the purchase process. The optimization infrastructure 1004 is configurable to work in conjunction with the checkout module 1016 to present contextually relevant calls to action to the user during the checkout process. In some examples, the optimization infrastructure 1004 can display only those coupons that can be applied to the items the user is attempting to checkout using the checkout module 1016. In certain examples, the checkout module 1016 can support selection of coupons stored in the coupon infrastructure 904 as well. The optimization infrastructure 1004 can instruct the checkout module 1015 to highlight a checkout now control within a user interface presented by the networked system 702 or provide other calls to action to incent the user to make a pending purchase.

### Example Method

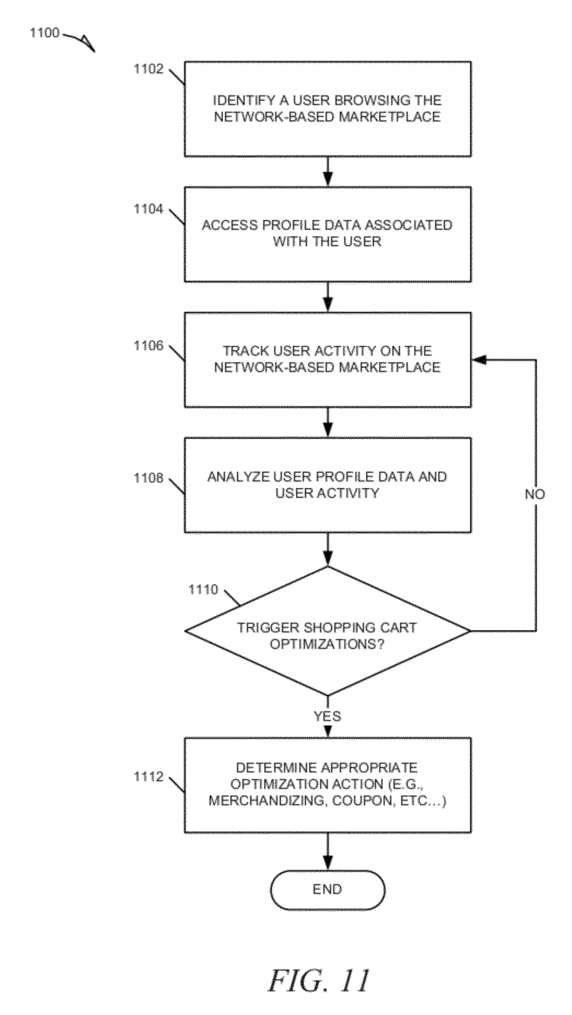

FIG. 11 is a flow chart illustrating an example method 1100 for optimizing shopping cart conversion using real-time behavioural modeling. In this example, the method 1100 can include operations such as: identifying a user at 1102, accessing provide data at 1104, tracking user activity at 1106, analyzing user profile data and user activity data at 1108, determining whether to trigger shopping cart optimizations at 1110, and determining appropriate optimization action at 1112.

In an example, the method 1100 can being at 1102 with the networked system 702 identifying a user session. In another example, the targeting module 1002 may identify a user with an active session with the networked system 702. At 1104, the method 1100 can continue with the networked system 702 accessing profile data associated with the identified user. At 1106, the method 1100 can continue with the networked system 702 tracking activity of the identified user within a marketplace hosted by the networked system 702. At 1108, the method 1100 can continue with the rules engine 1010 analyzing user profile data and user activity against a set of behavioural models. In an example, the behavioural models can be pre-processed offline based on historical transaction data. In another example, the behavioural models can be created in real-time based on both historical data and real-time data.

At 1110, the method 1100 can continue with the rules engine 1010 determining whether shopping cart (or other similar) optimizations should be triggered based on the behavioural analysis. If the rules engine 1010 determines that no optimizations should be triggered, the method 1100 can loop back to tracking user activity at 1106. At 1112, the method 1100 can conclude with the networked system 702 determining appropriate optimization actions to invoke based on the behavioural analysis.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but also deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

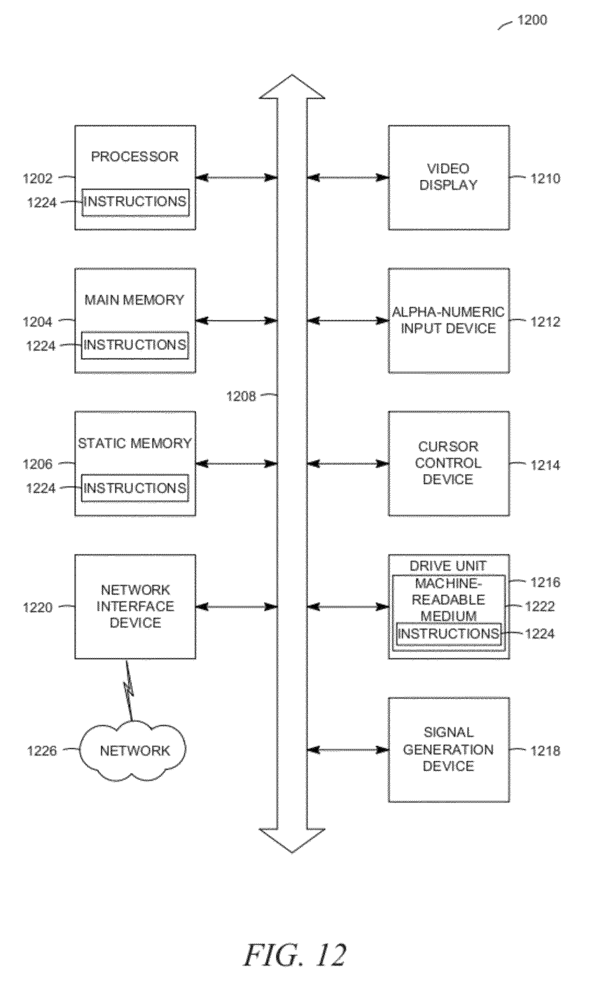

FIG. 12 is a block diagram of machine in the example form of a computer system 1200 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device 1214 (e.g., a mouse), a disk drive unit 1216, a signal generation device 1218 (e.g., a speaker) and a network interface device 1220.

### Machine-Readable Medium

The disk drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system to dynamically issue coupons to a user on a network-based publication system have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

What is claimed is:

1. A method comprising:
identifying, within a network-based system using one or more processors, a user interacting with content published by the network-based system;
accessing profile data associated with the user;
tracking, on the network-based system using the one or more processors, user activity associated with the user interacting with the content published by the network-based system;
accessing a behavioral model generated from historical data detailing interactions of a plurality of users with the network-based system.
applying, using the one or more processors, the behavioral model to the profile data and the tracked user activity; and
determining, based at least in part on the applying the behavioral model to the profile data and the tracked user activity, a shopping cart optimization to optimize shopping cart conversion.

2. The method of claim 1, wherein the applying the behavioral model includes determining, based at least in part on the tracked user activity, a phase of interaction with the network-based system associated with the user.

3. The method of claim 2, wherein the determining the phase of interaction includes selecting the phase of interaction from a group of phases including:
exploration;
active shopping;
checkout; and
abandonment.

4. The method of claim 2, wherein the determining the phase of interaction includes determining, based on the tracked user activity, a matching node within the behavioral model, wherein the behavioral model includes a hierarchy of nodes mapped to various phases of interaction within the network-based system.

5. The method of claim 1, wherein the determining the shopping cart optimization includes selecting a specific call to action to be triggered within the network-based system targeted at the user activity associated with the user.

6. The method of claim 5, wherein the selecting the specific call to action includes selecting a call to action from a group of calls to action including:
increased merchandising;
decreased merchandising;
real-time messaging; and
coupon presentment.

7. The method of claim 5, wherein the determining the shopping cart optimization includes determining whether the user activity indicates that the user intends to perform an action from a group of actions including:
checkout;
add items to a cart;
abandon a shopping cart with items; and
return to an abandoned cart.

8. The method of claim 7, wherein the determining the shopping cart optimization includes determining a predicted day of return to an abandoned cart.

9. A network-based system comprising:
one or more processors to execute a plurality of data processing modules, the data processing modules including:
a targeting module to:
identify a user interacting with the network-based system,
access profile data associated with the user, and
track user activity associated with the user;
a behavioral modeling engine to generate behavioral models based on historical data detailing interactions of a plurality of users with the network-based system; and
a rules engine to:
access a behavioral model generated by the behavioral modeling engine,
apply the behavioral model to the profile data and the tracked user activity associated with the user, and
select, from a call to action repository based on application of the behavioral model, a shopping cart optimization to optimize shopping cart conversion.

10. The network-based system of claim 9, wherein the rules engine is to determine, based at least in part on the tracked user activity, a phase of interaction with the network-based system associated with the user.

11. The network-based system of claim 10, wherein the rules engine is to select the phase of interaction from a group of phases including:
exploration;
active shopping;
checkout; and
abandonment.

12. The network-based system of claim 10, wherein the rules engine is to determine, based on the tracked user activity, a matching node within the behavioral model;
wherein the behavioral modeling engine generates a hierarchy of nodes mapped to various phases of interaction within the network-based system.

13. The network-based system of claim 9, wherein the rules engine is to select the shopping cart optimization at least in part by selecting a specific call to action to be implemented within a checkout module executed within the network-based system.

14. The network-based system of claim 13, wherein the rules engine selects a specific call to action from a group of calls to action including:
increased merchandising;
decreased merchandising;
real-time messaging; and
coupon presentment.

15. The network-based system of claim 13, wherein the rules engine determines, as part of selecting the shopping cart optimization, whether the user activity indicates that the user intends to perform an action from a group of actions including:
checkout;
add items to a cart;
abandon a shopping cart with items; and
return to an abandoned cart.

16. The network-based system of claim 15, wherein the rules engine determines a predicted day of return to an abandoned cart when the rules engine determines that the user intends to return to an abandoned cart.

17. A machine-readable storage medium including instructions that, when executed within a network-based system, cause the network-based system to:
identify a user interacting with content published by the network-based system;
access profile data associated with the user;
track user activity associated with the user interacting with the content published by the network-based system;
access a behavioral model, the behavioral model generated from historical data detailing interactions of a plurality of users with the network-based system.
apply the behavioral model to the profile data and the tracked user activity; and
determine, based at least in part on the applying the behavioral model to the profile data and the tracked user activity, a shopping cart optimization to optimize shopping cart conversion.

18. The machine-readable storage medium of claim 17, wherein the instructions that cause the network-based system to apply the behavioral model further include instructions that cause the network-based system to determine, based at least in part on the tracked user activity, a phase of interaction with the network-based system associated with the user.

19. The machine-readable storage medium of claim 18, wherein the instructions that cause the network-based system to determine the phase of interaction include instructions that cause the network-based system to determine, based on the tracked user activity, a matching node within the behavioral model, wherein the behavioral model includes a hierarchy of nodes mapped to various phases of interaction within the network-based system.

20. The machine-readable storage medium of claim 17, wherein the instructions that cause the network-based system to determine the shopping cart optimization include instructions that cause the network-based system to select a specific call to action to be triggered within the network-based system targeted at the user activity associated with the user, the call to action selected from a group of calls to action including:
checkout;
add items to a cart;
abandon a shopping cart with items; and
return to an abandoned cart.
